(19) United States
(12) Patent Application Publication
(10) Pub. No.: US 2014/0034562 A1
(43) Pub. Date: Feb. 6, 2014

(54) ELECTROLYTIC CHLORINATOR CONTROL

(71) Applicant: Astral Pool Australia Pty Ltd, (US)

(72) Inventor: Peter Ronald Wallace, Hope Island (AU)

(73) Assignee: ASTRAL POOL AUSTRALIA PTY LTD, Noble Park (AU)

(21) Appl. No.: 13/746,323

(22) Filed: Jan. 22, 2013

(30) Foreign Application Priority Data
Mar. 19, 2012 (AU) 2012901107

(51) Int. Cl. C02F 1/00

(52) U.S. Cl. CPC C02F 1/008
USPC 210/138

(57) ABSTRACT

A control unit for a swimming pool electrolytic cell. The control unit includes a housing containing a logic module. An electrical connection is provided to connect the logic module to an electrical supply to receive power therefrom. An electrical connection is provided to connect the logic module to electrodes of the cell. A data outlet is provided to send control signals from the logic arrangement to a variable speed pump. The logic module is configured to: selectively supply power to the electrodes to energize the electrodes; and control the output of the pump, when the pump is active, to suit electrolytic chlorination.

### FIELD OF THE INVENTION

This invention relates to the chlorination of swimming pools.

“Swimming pools” as used herein is used interchangeably with “pools” to refer to swimming pools, spas, Japanese hot tubs and like bodies of water for bathing.

### BACKGROUND

Electrolytic chlorinators are used in swimming pools to produce sanitizer. Typical electrolytic chlorinators include a cell and a remotely mounted control unit for controlling the cell. A set of spaced electrodes are mounted in the cell and energised by the control unit. Water from the pool is driven by a pump to move through the cell. As the water moves through the cell it is electrolysed to convert dissolved salts into sanitizer.

In some existing pool water treatment systems, the pump is powered by an outlet socket in the chlorinator controller. The outlet socket is turned on and off by an inbuilt timer system in the chlorinator controller to ensure there is sufficient water flow to safely operate the cell. The outlet socket provides power to the pump which operates at a predetermined speed or flow rate.

The performance of the pump should match the performance of the chlorinator. If the water is flowing too slowly, the gaseous products of electrolysis, predominantly hydrogen and oxygen, may accumulate in the cell, filter or other equipment. This is dangerous. On the other hand, if the water is flowing faster than needed the pump is likely consuming significantly more power than needed. This is wasteful. Moreover the pump is likely generating more noise and heat and is likely to wear out sooner.

In the past pumps have been selected to effectively back wash or clean a sand filter and circulate water to all parts of the pool. This may well be a compromise between a flow rate best suited for the filtration cycle and circulation of water and the requirement to back wash a sand filter or vacuum the pool. The inventor has realised that the flow rate of the selected pump is typically not ideal for electrolytic chlorination. Moreover, suppliers must carry a range of pumps to suit a range of desired flow rates.

More recently variable speed pumps, including multi-speed pumps and continuously variable speed pumps, have been applied to swimming pools. While such pumps go some way to addressing the problems of single speed pumps their introduction has complicated the control arrangements associated with swimming pools. An existing approach involves the addition of a control panel which sends control signals to the chlorinator and the pump.

It is an object of the invention to simplify the control arrangements associated with swimming pools.

It is not admitted that any of the information in this patent specification is common general knowledge, or that the person skilled in the art could be reasonably expected to ascertain or understand it, regard it as relevant or combine it in any way at the priority date.

### SUMMARY

Accordingly the invention provides a control unit for a swimming pool electrolytic cell, comprising:
a housing containing a logic module;
a first electrical connection component adapted to connect the logic module to an electrical supply to receive power therefrom;
a second electrical connection component adapted to connect the logic module to electrodes of the cell; and
a data outlet adapted to send control signals from the logic module to a variable speed pump;
wherein the logic module is configured or configurable to
   selectively supply power to the electrodes to energize the electrodes; and
   control the output of the pump when the pump is active.

In preferred forms of the invention the pump is configured to operate at a plurality of discrete performance settings, e.g. three discrete performance settings. The logic module may be configured or configurable to specify one, e.g. a lowest, of the discrete performance settings to suit electrolytic chlorination. By way of example each discrete performance setting may deliver a respective constant speed (rpm), pressure or flow.

Preferably the logic module is configured or configurable to selectively supply power and control in accordance with a timetable. Most preferably the schedule includes two or more periods in which the pump is active and the logic module is configured or configurable to control the output of the pump to deliver during at least one of the periods an output which differs from the output during at least one other of the periods in which the pump is active.

According to another aspect, the invention features a water treatment system including the control unit, electrolytic cell, and the pump.

According to a still further aspect, the invention features a pool installation including the water treatment system and a body of water.

### BRIEF DESCRIPTION OF THE DRAWINGS

Various exemplary features are illustrated.

FIG. 1 is a schematic diagram of a pool filtration system with an electrolytic chlorinator control system according to the invention;

FIG. 2 is a schematic, block diagram illustrating the electrolytic chlorinator control system used in the pool filtration system shown in FIG. 1; and

FIG. 3 is a front view of a user interface on the electrolytic control system shown in FIG. 2.

### DESCRIPTION OF AN EMBODIMENT

The following examples are intended to illustrate the scope of the invention and to enable reproduction and comparison. They are not intended to limit the scope of the disclosure in any way.

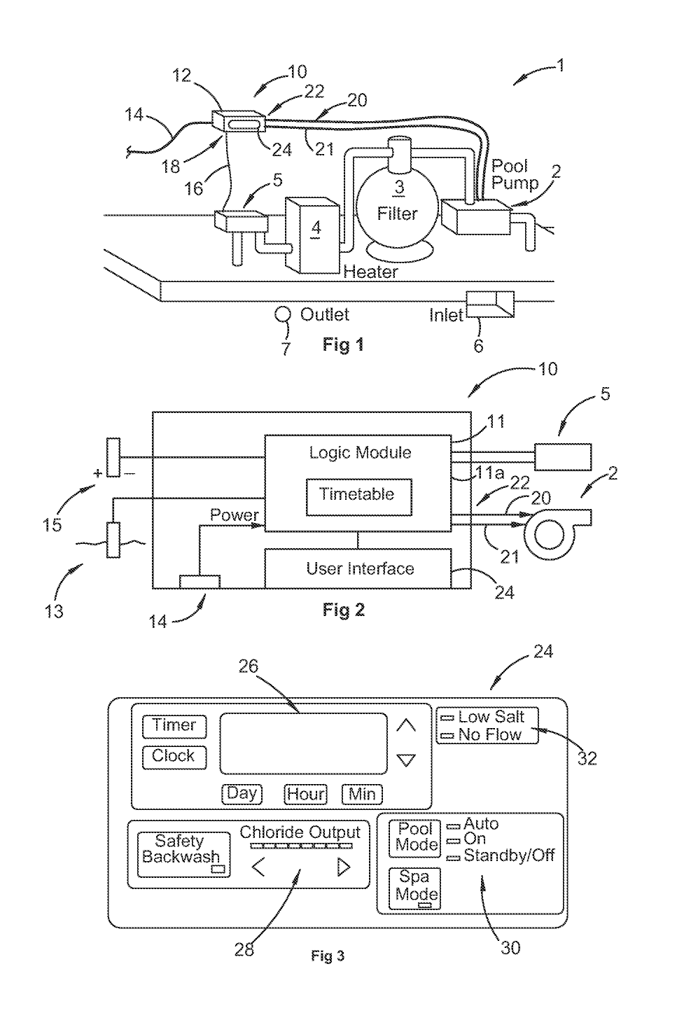

FIG. 1 illustrates a swimming pool filtration system 1. The system 1 includes a pump 2, a filter 3, a heater 4, and an electrolytic cell 5. Plumbing interconnects the pump, filter, heater, and cell and connects these elements with a swimming pool to define a fluid circuit. The pump 2 drives water about the fluid circuit. Water is drawn from the pool via an inlet in the form of a skimmer box 6 and then driven in series through the filter 3, heater 4, and cell 5 before being returned to the pool via an outlet 7.

The system 1 further includes a control unit 10 for controlling the pump 2 and the cell 5 in a coordinated manner. As illustrated in FIG. 2, the control unit 10 includes a logic module 11 within housing 12 containing suitable electronics (not illustrated explicitly). The control unit further includes an incoming electrical connection component 14, which is adapted to receive and provide electrical power to the logic module 11. For example, the incoming electrical connection component 14 could be a power supply cord by means of which the control unit is connected to a conventional power outlet to receive electricity from a mains supply. Alternatively, the incoming electrical connection component 14 could be a socket with electrical pins/prongs adapted to receive the female end of an extension cord.

The control unit 10 further includes a second, output electrical connection component 18, e.g., in the form of a socket, adapted to connect the electronics of the control unit 10 to the cell 5 so as to provide energizing electrical power to the electrodes of the cell 5. For example, a lead 16 could terminate in a plug cooperable with the socket 18 to connect the control unit 10 and the cell 5.

The control unit 10 also includes a data outlet 22 in the form of a socket adapted to send control signals to the pump 2. A lead 20 could terminate in a plug cooperable with the socket 22 to connect the unit control unit 10 and the pump 2.

The control signal may take a variety of forms. Preferably a transformer (not shown) is interposed along the lead 20 and connected to the mains supply to supply a voltage of 24 volts to the lead 20, and the electronics of the module 10 receive this voltage and generate a signal by varying a milliamp current along the lead 20. Alternatively the electronics of the control unit 10 may supply a voltage to the lead 20. Indeed, power sufficient to power the pump 2 and data may be simultaneously transmitted along the line 20 in the manner of power line communication (PLC). The use of PLC could allow a conventional power socket to be a data outlet. In a simple implementation of the invention, the lead 20 and the socket 22 may define multiple conduction paths corresponding to separate speed windings within the pump motor, in which case the control signal would be the selective energisation of the conduction paths.

In a preferred form of the invention the control unit 10 powers the pump 2 via a separate power lead 21.

The control unit 10 includes a logic module 11 for controlling the efficient operation of the pump 2 and of the cell 5, which logic module 11 could be implemented via hardware, software, or a combination of hardware and software. In the illustrated arrangement, the logic module 11 includes a timing arrangement to operate the pump and the cell in accordance with a timetable 11a. It is also contemplated that the control unit may simply operate the pump and the cell in response to various inputs, e.g. in response to a sensor 13 indicative of sanitizer concentration in the pool water and/or a sensor 15 located within the cell 5 (e.g., right by the cell's positive and negative electrodes, as schematically illustrated) indicative of sanitizer production levels in the cell 5. Preferably the timetable is structured for an operating period in the vicinity of four hours each morning and each evening to treat the pool water before and after the sun is out. Sunlight tends to destroy pool sanitizer. Treating the water outside of daylight hours is more efficient because the sanitizer lasts longer to destroy more undesirable biological species.

The described pump 2 may be a three-speed pump incorporating an infinitely variable motor and a variable frequency drive configured to define the three speeds. Desirably each of the three speeds may be selectably varied to suit different operations. The electrodes may not be energised during all periods when the pump is active. Preferred variants of the control unit are configured to control the output of the pump to suit filter system and pool circulation requirements.

The control signals from the control unit 10 tell the pump 2 at which of the three speeds it should operate. Typically the lowest speed setting will be configured to suit chlorination. The higher speed settings are reserved for other operations such as operating a vacuum cleaning apparatus or more rapidly filtering and cleaning a cloudy pool.

The control unit 10 preferably includes a user interface 24, illustrated in FIG. 3, for displaying information to and receiving input from a user. The interface 24 suitably includes:
a programming area 26 for setting the operating timetable;
a chlorine output control 28 which indicates the amount of chlorine being produced;
a user mode area 30 for controlling the pump and chlorinator, e.g. by selecting pre-set modes, e.g. a respective mode for pool and spa operation;
a warning display 32 for warning a user if there is no flow or if there is insufficient salt in the pool.

Via the interface 24, a user can set the on-time for the cell 5 and the speed at which the pump is to operate while the cell is on (e.g. high, medium, or low) and then select the time at which the chlorinator and pump should turn off. The described variant of the invention allows for up to four operating periods per day to be scheduled in the timetable. The operating periods may have different durations and pump operating speeds. The control unit 10 is desirably mounted remotely from the pool to permit convenient access to its user interface 24, although it is also contemplated that the logic module might be integrated with one of the pump 2 and the cell 5.

Preferably the logic module is configured to deliver a low pump output for most of the day and to periodically throughout the day increase the output of the pump. Operating at a low output is energy efficient but carries the risk of voids of uncirculated, or poorly circulated, water in the pool. Periodically operating the pump at higher output desirably moves the water in these voids.

It is desirable that the control unit be configured to de-energise the electrodes prior, say about five minutes prior, to deactivating the pump. This reduces the risk of sanitizer, such as chlorine, concentrations sitting in components of the pool water treatment system and in turn reduces the risk of accelerated corrosion of these components. In particular, gas heaters are susceptible to corrosion caused by accumulated sanitizer.

It will be appreciated that various modifications to and departures from the exemplary disclosed embodiments will occur to those having skill in the art. What is deemed to be protected is set forth in the following claims.

1. A control unit for a swimming pool electrolytic cell, comprising:
a housing containing a logic module;
a first electrical connection component adapted to connect the logic module to an electrical supply to receive power therefrom;
a second electrical connection component adapted to connect the logic module to electrodes of the cell; and
a data outlet adapted to send control signals from the logic module to a variable speed pump;
wherein the logic module is configured or configurable to
selectively supply power to the electrodes to energize the electrodes; and
control the output of the pump when the pump is active.

2. The control unit of claim 1, wherein the pump is configured to operate at a plurality of discrete performance settings.

3. The control unit of claim 2, wherein the pump is configured to operate at three discrete performance settings.

4. The control unit of claim 2, wherein the logic module is configured or configurable to generate the control signals to control the pump to deliver a lowest of the discrete settings when the electrodes are energized.

5. The control unit of claim 1, wherein the logic module is configured or configurable to selectively supply power and control in accordance with a timetable.

6. The control unit of claim 5, wherein the timetable includes two or more periods in which the pump is active and the logic module is configured or configurable to control the output of the pump to deliver, during at least one of the periods, an output which differs from the output during at least one other of the periods in which the pump is active.

7. A water treatment system, comprising:
a control unit;
an electrolytic cell; and
a variable speed pump;
wherein the control unit includes
a housing containing a logic module;
a first electrical connection component adapted to connect the logic module to an electrical supply to receive power therefrom;
a second electrical connection component adapted to connect the logic module to electrodes of the cell; and
a data outlet adapted to send control signals from the logic module to a variable speed pump; and
wherein the logic module is configured or configurable to
selectively supply power to the electrodes to energize the electrodes; and
control the output of the pump when the pump is active

8. A pool installation, comprising:
a body of water; and
a water treatment system configured and arranged to sanitize the body of water, the water treatment system comprising
a control unit;
an electrolytic cell; and
a variable speed pump;
wherein the control unit includes
a housing containing a logic module;
a first electrical connection component adapted to connect the logic module to an electrical supply to receive power therefrom;
a second electrical connection component adapted to connect the logic module to electrodes of the cell; and
a data outlet adapted to send control signals from the logic module to a variable speed pump; and
wherein the logic module is configured or configurable to
selectively supply power to the electrodes to energize the electrodes; and
control the output of the pump when the pump is active.
